(19) United States
(12) Patent Application Publication
(10) Pub. No.: US 2007/0081102 A1
(43) Pub. Date: Apr. 12, 2007

(54) Apparatus and method for automatically adjusting white point during video display

(75) Inventors: Rajeev Ramanath, Plano, TX (US); Gregory S. Pettitt, Farmersville, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/247,878

(22) Filed: Oct. 11, 2005

(51) Int. Cl. H04N 5/58

(52) U.S. Cl. 348/602

(57) ABSTRACT

The present disclosure relates to systems and processes for automatically adjusting the white point of displayed images to account for changes in ambient light. In one embodiment, a display system includes a display device having sensors for recording the red (R), green (G) and blue (B) values for ambient light and measuring the intensity of such light. The sensors feed these values into a processor, which calculates R, G, B gain values to be applied to the video input R, G, B values. In this manner, the display device can account for changes in ambient light to adjust the perceived white point accordingly. Related methods for automatically adjusting the white point of a perceived image are also described.

### TECHNICAL FIELD

The present disclosure relates to automatic adjustment of white point of display systems.

### BACKGROUND

Display system images can be negatively affected in a variety of manners. For example, the colorfulness of an image can degrade under certain conditions, thereby negatively affecting the appearance of the image to the viewer. Often, ambient light distorts the colorfulness of an image by corrupting the “white point” of an image—i.e., the point that can be considered as the whitest point in the image—and overall image contrast.

Display systems each have their own intended white point, which is typically determined by the manufacturing specifications of the device. The intended white point, however, can be corrupted by extrinsic or ambient light due to the effect such light has on the image perceived by the viewer. For example, an image in a dark room will look more clear and colorful than an image being viewed in a sunroom. Indeed, the sunroom will have an abundance of ambient light that will negatively affect the perceived image. The degradation of the image in the sunroom can be attributed to the white point and contrast adjustment caused by ambient light.

Some display devices incorporate a manual white point adjustment control, which can be manipulated to achieve a desired white point adjustment. However, such devices are typically difficult to operate and require manual intervention to effect the desired change.

### BRIEF SUMMARY

The present disclosure relates to improving display images by implementing systems and processes for automatically adjusting the white point and contrast of such images to account for changes in ambient light. In one embodiment, a display system includes a display device having sensors for recording the red (R), green (G) and blue (B) values for ambient light (i.e., light in the viewing area extrinsic to the display device) and measuring the intensity of such light. The sensors feed these values into a processor, which calculates R, G, B gain values to be applied to the video input R, G, B values. In this manner, the display device can account for changes in ambient light to adjust the perceived white point accordingly. Related methods for automatically adjusting the white point of a perceived image are also described.

In some embodiments, automatic white point correction may only occur after certain conditions are satisfied. In one example, the systems and methods of the present disclosure may incorporate processes for adjusting white point only when the average white point change over time is varying relatively slowly. Still further, processes may be incorporated for accounting for reflection effects on the perceived image.

### BRIEF DESCRIPTION OF THE DRAWINGS

Reference is now made to the following descriptions taken in conjunction with the accompanying drawings, in which:

FIG. 1 illustrates a schematic depiction of an exemplary display system according to the present disclosure;

FIG. 2 illustrates a graphical depiction of exemplary sensor sensitivities;

FIG. 3 illustrates a block diagram of an exemplary hardware architecture for making automatic white point adjustments;

FIG. 4 illustrates a graphical depiction of exemplary white point shifts;

FIG. 5 illustrates a process flowchart depicting an exemplary process for effecting white point correction;

FIGS. 6A-C illustrate graphical depictions of three-dimensional (3-D) gain maps associated with extraction of gain values; and

FIG. 7 illustrates an exemplary process for implementing linear or nonlinear corrections.

### DETAILED DESCRIPTION

Digital video signals generally comprise a series of image frames, which include a large number of image pixels to formulate a desired image. Ideally, the images displayed by the image frames are of a desirable colorfulness from the perspective of the viewer. However, ambient light can negatively affect the desired image by corrupting the white point of the display device. The principles of the present disclosure seek to improve the resultant image by automatically adjusting the white point of the perceived image.

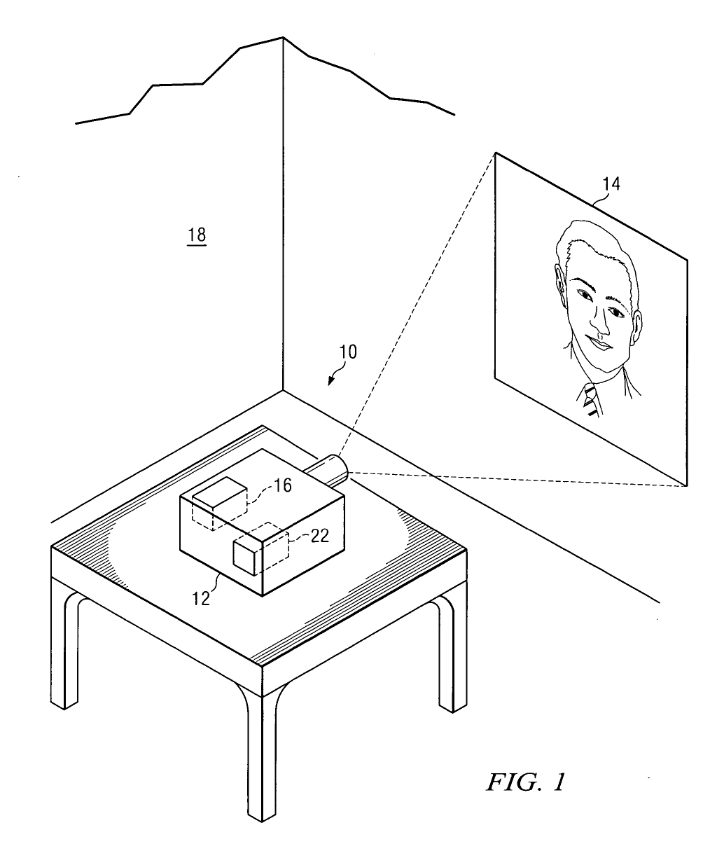

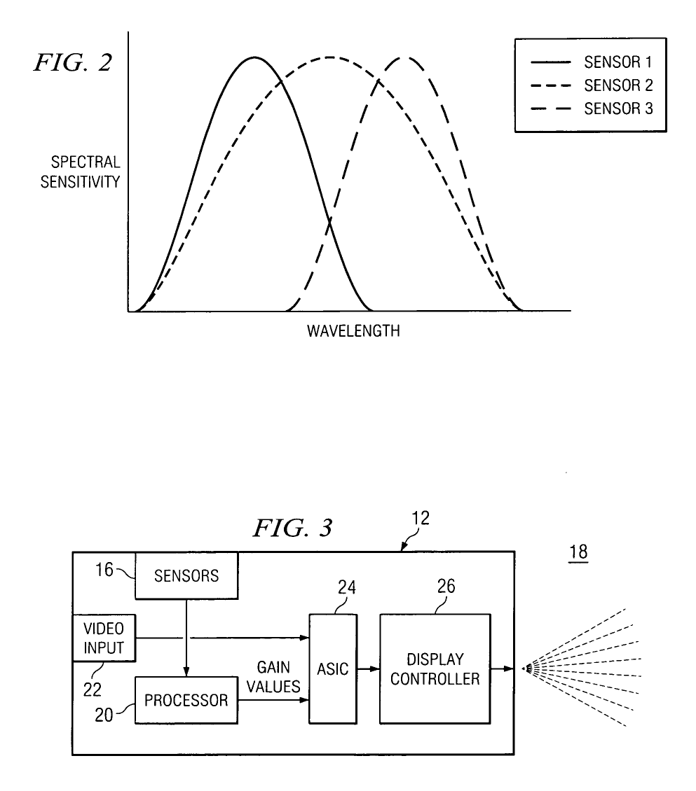

Referring to FIG. 1, in one embodiment, a display system 10 includes a video projector 12 for projecting video images on a projector screen 14. Although exemplary embodiments will be described in the context of video projector systems, it is to be appreciated that the principles of the present disclosure can be adapted to a variety of display systems, including digital rear projection televisions (e.g., a Digital Light Processing or DLP® televisions), front projection systems and direct view devices (e.g., LCD or plasma devices). The projector 12 includes one or more sensors 16, which are adapted to measure spectral content of ambient light, generally denoted by reference numeral 18, in terms of light and intensity. For example, referring to FIG. 2, each sensor 16 may include three channels of information corresponding to three different spectral sensitivities (e.g., R, G, B) over the visible wavelength range. In one embodiment, the second channel of information (G) spans the entire visible spectrum to reduce possible singular states that may occur in later processes. An additional fourth channel of information corresponding to dark noise (e.g., Z) may also be provided. In implementation, one “sensor” may house all channels of information or each sensor may correspond to one or more channels of information. The sensors 16 may be charged-coupled device (CCD) sensors, which are suitable for converting measured light into electronically conveyable information such as frequency or voltage. Of course, other suitable sensors other than CCD sensors are contemplated. Also, any number of sensors having any number of spectral sensitivities are contemplated. Indeed, the use of a large number of sensors may yield a relatively more accurate white point by performing an average operation over multiple sensors and possibly multiple spectral bands.

In a general sense, and with reference to FIG. 3, the sensor 16 transmits R, G, B, Z information of the ambient light to a processor 20, which carries out various processes on the received data. In one example, the processor 20 is a DSP/ARM processor. The processor 20 computes gain values to be applied to R, G, B values of a video input 22. In practice, video signals are received from a variety of sources, generally designated as video input 22 in FIG. 3. Sources include, but are not limited to, a cable box, a digital videodisc player, a videocassette recorder, a digital video recorder, a TV tuner, a computer and a media center. The video input 22 transmits R, G, B information to an application specific integrated circuit (ASIC) 24, which applies the gain values determined by the processor 20 to the video input R, G, B values. The ASIC 24 then sends the adjusted video input values to a display controller 26, which manipulates the video signal for display. In one embodiment, the display controller 26 includes a digital micromirror device (DMD), which conditions the video signal for display. In practice, the ASIC 24 and display controller 26 may comprise separate or singular components.

In conventional video display systems, the video images transmitted from the video input 22 are displayed in a manner consistent with the device-specific, or intended, white point of the video device (e.g., the projector 12 of the exemplary embodiment). It is to be appreciated that the display's intended white point may not be constant. Rather, the intended white point may be changed by firmware settings. Indeed, a particular device may have several stored “intended” white points and the user may choose a desired intended white point from a number of stored white points. Also, instead of using a stored white point, the user may choose to configure a new intended white point based on the user's perception of an optimal viewing white point. The intended white point may also be referred to as the reference white point.

In a mathematical sense, the intended white point can be expressed as Xₙ, Yₙ, Zₙ, which are tristimulus values corresponding to R, G, B values of the device. In practice, the intended white point of the display device is corrupted by ambient light, the white point of which can be expressed as Xₐ, Yₐ, Zₐ, which are the tristimulus values corresponding to the R, G, B values of the ambient light. Consequently, instead of viewing an image having an optimal display consistent with the intended white point of the device, the viewer will view an image corrupted by ambient light. The white point from the viewer's vantage point can be expressed in terms of tristimulus values as Xₘ, Yₘ, Zₘ where Xₘ=Xₙ+Xₐ, Yₘ=Yₙ+Yₐ and Zₘ=Zₘ+Zₐ.

The present disclosure relates to automatic adjustment of the video signal prior to display in order to account for undesirable ambient light conditions. That is, video display systems according to the present disclosure measure ambient light and use such measurements to adjust the video input signal to achieve a technical optimization of the image white point perceived by the viewer. In one example, such technical optimization may be achieved by adjusting, or shifting, the perceived white point of the viewer as close as possible to the intended white point of the display device. As will be described, automatic adjustment of the video input signal is realized through the calculation of gain values and the application of such gain values to the R, G, B values of the video input signal.

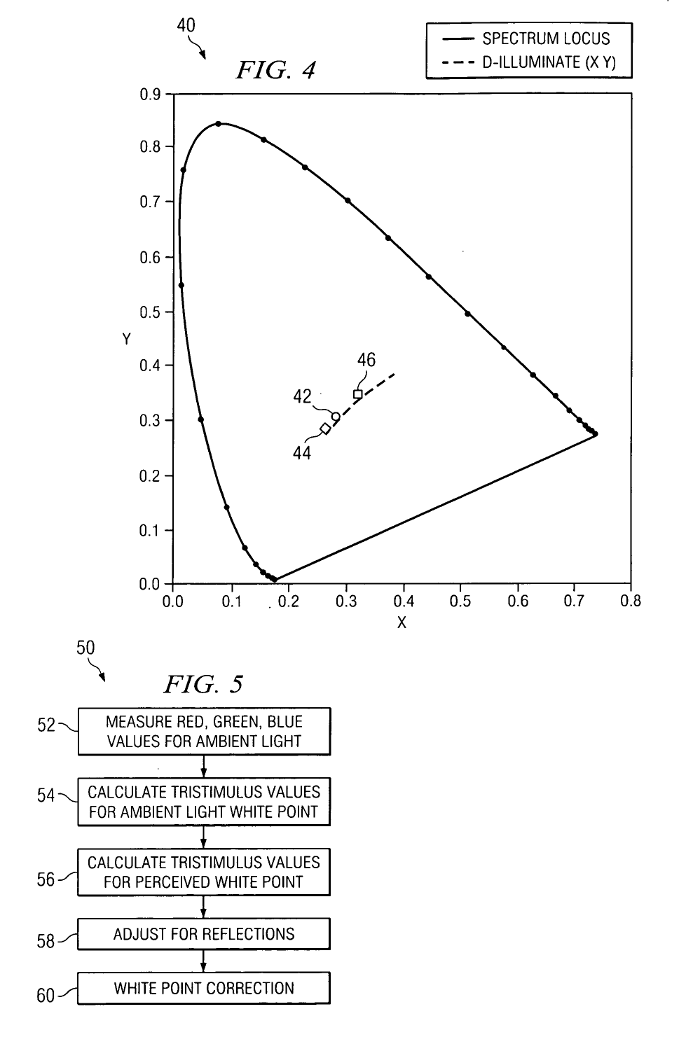

The ratio space associated with changes in white point can be better appreciated with reference to FIG. 4. In this graphical depiction of a ratio space 40, an exemplary reference white point 42 is mapped to an x-y coordinate system. When ambient light changes to a relatively bluish hue, the associated white point may shift to a bluish white point 44 in the ratio space 40. In another example, ambient light may change to a relatively yellowish hue, which can be mapped as a yellowish white point 46 in the ratio space 40. Accordingly, it may be desirable to shift the bluish white point 44 or the yellowish white point 46 back to the reference white point 42 to achieve desired clarity and contrast of the displayed image.

Through the acquisition and manipulation of data, the systems and methods of the present disclosure automatically adjust the perceived white point towards the intended or reference white point for optimal viewing. Referring to FIG. 5, an exemplary acquisition and manipulation process 50 is shown wherein the sensors first measure R, G, B values for ambient light 52. These R, G, B values are then converted into manipulable tristimulus values 54 via calculations carried out at the processor 20. As an example, the R, G, B values measured by the sensors 16 (FIG. 1) at any time (e.g., t+1) can be converted into tristimulus values using a conversion matrix B calculated as follows: B=S^{t}A[S^{t}S]⁻¹ where S is the matrix of sensor-specific spectral sensitivities and A is a matrix of standard observer color matching functions. The R, G, B values measured by the sensors 16 are transformed into tristimulus values by multiplying the measured R, G, B values by the conversion matrix B. As discussed above, such values may be expressed as Xₐ, Yₐ, Zₐ.

Also relevant to this analysis are the tristimulus values corresponding to the intended white point of the display device 12 (FIG. 1). The intended white point tristimulus values are typically already stored in a memory device (not shown) associated with the processor. As discussed above, such values may be expressed as Xₙ, Yₙ, Zₙ. Once the tristimulus values corresponding to the intended white point and the ambient white point are obtained, the processor 20 may then calculate the tristimulus values corresponding to the perceived white point 56, i.e. Xₘ, Yₘ, Zₘ. As discussed above, such values may be calculated as follows: Xₘ=Xₙ+Xₐ, Yₘ=Yₙ+Yₐ and Zₘ=Zₙ+Zₐ. In sum, the following three data sets are now available:

Xₙ, Yₙ, Zₙ—tristimulus values of the white point of the display device;

Xₐ, Yₐ, Zₐ—tristimulus values of the white point of the ambient light; and

Xₘ, Yₘ, Zₘ—tristimulus values of the white point perceived by the viewer.

Once the tristimulus data sets are available, the processor 20 may optionally first compensate for reflection adjustments before proceeding with automatic white point correction. Oftentimes, ambient light will cause undesirable reflections on the display screen that factor into the ambient light measured in the room. In such scenarios, it may be desirable to build in a reflection coefficient into the data manipulation process 50 to account for such reflections. That is, the ambient light measured by the sensors 16 can be adjusted to account for the shift in white point attributed to reflection experienced by display screens having a non-zero reflection factor. In one embodiment, reflection adjustments 58 may be accounted for by introducing a reflection factor into the equation used to calculate the tristimulus values perceived by the viewer. For example, the perceived tristimulus values may be calculated according to the following equation: [Xₘ, Yₘ, Zₘ]=[Xₙ, Yₙ, Zₙ]+a[Xₐ, Yₐ, Zₐ] where “a” is a measure of the reflection factor associated with the display screen. In practice, a viewer may select the reflection factor to be commensurate with the amount of reflection incurred by the display screen. In other embodiments, the processor 20 may assign the measure “a”. The perceived tristimulus values with reflection adjustment are then normalized by scaling the tristimulus values. In one example, Yₘ is set to 1 and the normalized tristimulus values are calculated as follows: [Xₙₒᵣₘ, Yₙₒᵣₘ, Zₙₒᵣₘ]=[Xₘ, Yₘ, Zₘ]/(Yₘ).

After optionally manipulating the data for reflection adjustments, various processes may be carried out to automatically adjust the white point of images 60 displayed by the display device. In particular, the white point now perceived by the viewer can be considered to be a combination of the intended white point and the ambient light white point. That is, the perceived white point is the intended white point corrupted by ambient light. Mathematically, the white point perceived by the viewer can be calculated in terms of tristimulus values as follows: [X′ₙ, Y′ₙ, Z′ₙ]=b[Xₙₒᵣₘ, Yₙₒᵣₘ, Zₙₒᵣₘ]+(1−b)[Xₐ, Yₐ, Zₐ] where “b” is a measure of how dominant the display device white point is over the ambient light white point. In practice, the processor 20 is capable of performing this calculation and assigning an appropriate measure of “b”, e.g. 0.2. In other embodiments, the measure “b” is manually entered.

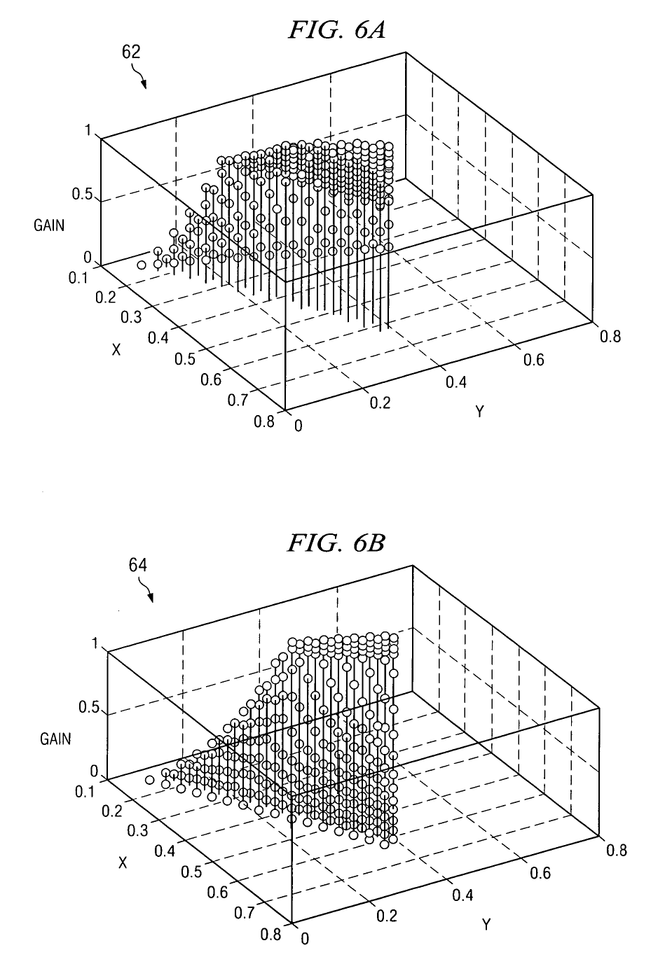

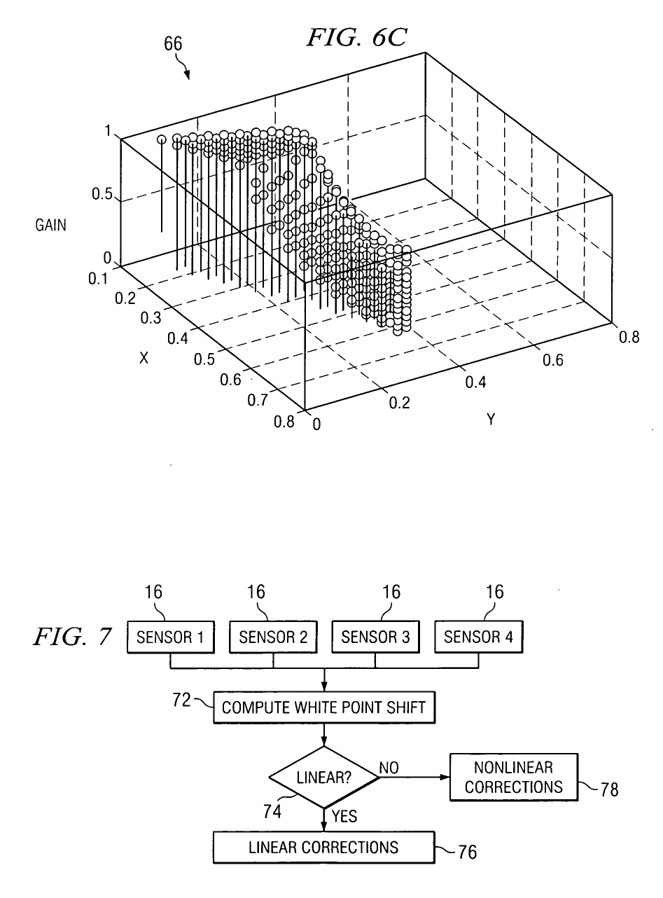

Once the perceived white point tristimulus values X′ₙ, Y′ₙ, Z′ₙ, are obtained, the processor 20 may then use such values to obtain the appropriate gain values to be applied to the video input signal to shift the perceived white point towards the intended white point. In one embodiment, the processor 20 first manipulates the tristimulus values X′ₙ, Y′ₙ, Z′ₙ to obtain scaled x′ₙ and y′ₙ values: x′ₙ=X′ₙ/(X′ₙ+Y′ₙ+Z′ₙ) and y′ₙ=Y′ₙ/(X′ₙ+Y′ₙ+Z′ₙ). Referring to FIGS. 6A-C, the processor 20 uses the x′ₙ, y′ₙ values to extract gain values from three or more three-dimensional (3-D) gain maps stored in the processor. The 3-D gain maps are provided to model the gain surface associated with shifts in white point. The 3-D gain maps correspond to the primary colors red 62 (FIG. 6A), green 64 (FIG. 6B) and blue 66 (FIG. 6C). In some embodiments, the processor 20 may interpolate the gain values depending on the sampling provided by the modeled gain surfaces. In any event, the processor 20 extracts the gain values required to shift the corrupted white point to the intended white point and transmits these gain values to the ASIC 24 (FIG. 3), which applies the gain values to the video input R, G, B values. In practice, the gain values may be sent to the ASIC in an incremental, or hysteresis-like, manner, thereby gradually moving the displayed white point toward the intended white point.

In one embodiment, the ASIC 24 utilizes a P7 matrix to calculate adjusted video R, G, B values. That is, the video input R, G, B values fed to the ASIC 24 are adjusted to account for white point shifts via manipulations carried out via a P7 matrix. In practice, the gain values determined by the processor 20 are used to populate the “white” column of the P7 matrix:

$$[ \begin{matrix}R & G & B & C & M & Y & W \\ 1 & 0 & 0 & 0 & 1 & 1 & {R}_{gain} \\ 0 & 1 & 0 & 1 & 0 & 1 & {G}_{gain} \\ 0 & 0 & 1 & 1 & 1 & 0 & {B}_{gain}\end{matrix} ]$$

Details regarding the P7matrix and associated P7 matrix calculations may be ascertained from U.S. Pat. No. 6,594,387, assigned to Texas Instruments, Inc. U.S. Pat. No. 6,594,387 is incorporated herein by reference for all legitimate purposes. P7 calculations may be performed on a pixel by pixel basis. As an example, a video input signal may be found to have the following R, G, B values: R=100, G=150 and B=70. The P7 matrix first decomposes the video input R, G, B values to determine the corresponding primary (P), secondary (S) and white (W) values for the pixel. First, the white component of the pixel is extracted by reducing the lowest of the three values to zero (e.g., by subtracting 70 from each R, G, B value): R=30, G=80, B=0. Accordingly, in this example, the white component equals 70 (W=70). Next, the secondary component of the pixel is extracted by reducing the current lowest value to zero (e.g., by subtracting 30 from the R and G values): R=0, G=50, B=0. Accordingly, the secondary component, yellow (combination of red and green), equals 30 (S=30). The primary component is then extracted by reducing the remaining value to zero (e.g., by subtracting 50 from the G value): R=0, G=0, B=0. Accordingly, the primary component, green, equals 50 (P=50).

As a result of the decomposition process, the green, yellow and white columns of the P7 matrix are extracted to form a 3×3 matrix. This extracted 3×3 matrix is then multiplied by the P, S, W values to determine the adjusted video input R′, G′, B′ values:

$$[ \begin{matrix}R′ \\ G′ \\ B′\end{matrix} ] = [ \begin{matrix}0 & 1 & {R}_{gain} \\ 1 & 1 & {G}_{gain} \\ 0 & 0 & {B}_{gain}\end{matrix} ] * [ \begin{matrix}P \\ S \\ W\end{matrix} ]$$

In this manner, the video input signal R, G, B values are adjusted to R′, G′, B′ values, which account for a white point shift towards the intended white point. Accordingly, the image perceived by the viewer through display of the R′, G′, B′ values will have a white point corresponding to the intended white point, thereby achieving technically optimal colorfulness and contrast. It is to be appreciated that the foregoing description is merely exemplary and that the particular image pixel being decomposed will determine whether the secondary component is cyan, magenta or yellow and whether the primary component is red, green or blue. Also, although the determined gain values are herein described as being applied to the video input signal in a nonlinear fashion via the P7 matrix, it is to be appreciated that other nonlinear corrections may be utilized, including those operating outside of the R, G, B space. Still further, linear corrections may be utilized by plugging the determined gain values into a 3 x 3 matrix as follows:

$$[ \begin{matrix}{R}_{gain} & 0 & 0 \\ 0 & {G}_{pain} & 0 \\ 0 & 0 & {B}_{gain}\end{matrix} ]$$

FIG. 7 illustrates processing stages for performing desired linear or nonlinear corrections. As previously discussed, sensors 16 measure ambient light and transmit ambient light information to the processor, which computes white point shift 72 in the form of gain values. At this point, it is determined whether the desired correction is linear or nonlinear 74, after which the appropriate correction (linear 76, nonlinear 78) is implemented.

Each pixel of the video input signal may be adjusted to account for automatic white point adjustment. However, such frequent adjustments are typically not desirable. Rather, automatic white point adjustment according to the present disclosure may be configured to not occur unless certain conditions are found to exist. For example, the processor 20 may take into account ambient light conditions in evaluating whether to effect automatic white point correction. Indeed, relatively dim ambient light conditions can be largely affected by changes in scene content. In such scenarios, it may not be desirable to employ automatic white point correction. On the other hand, relatively bright ambient light conditions are not largely affected by changes in scene content, and therefore, it may be desirable to employ automatic white point correction. In practice, the processor 20 may monitor the R, G, B values provided by the sensors 16 and evaluate whether the sum of the R, G, B sensor readouts is above a configurable threshold. In this manner, the processor 20 can effectively monitor whether ambient lighting conditions are relatively dim (under the threshold) or relatively bright (above the threshold). The processor 20 can also evaluate whether the measured ambient lighting conditions are too dominant in one or two channels (e.g., too dominant in the red or green channels). Such measurements typically indicate that the scene content is having a large effect on ambient lighting conditions. Accordingly, white point correction can be configured to only take place when all three R, G, B values are above a configurable threshold. As a result of the foregoing analysis, the processor 20 can determine whether to send gain values to the ASIC 24. As discussed above, application of the gain values to the input video signal may occur incrementally over time.

In another example, the processor 20 can monitor the average white point change over time and only effect white point correction when the average change is zero or very small. In practice, the processor 20 may employ a counter to measure white point shifts over certain time increments (e.g., t+1, t+2, t+3 . . . t+n). By monitoring the average change in the white point ratio-space over time, the processor 20 can avoid arbitrary shifts in white point due to the content being displayed.

While various embodiments for making automatic white point adjustments according to the principles disclosed herein have been described above, it should be understood that they have been presented by way of example only, and not limitation. For example, although the processor 20 is described as being intrinsic to the display device 12, it is to be appreciated that the processor 20 and other hardware associated with automatically adjusting the white point of displayed images may be incorporated into a another unit, such as a standalone unit separate from the display device. Rather, the following claims should be construed broadly to cover any embodiment tailored to achieve automatic white point correction. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method for making automatic white point adjustments during video display, comprising:
providing a display system for displaying video images, the display system having a first white point;
measuring ambient light conditions, the ambient light having a second white point, whereby the second white point corrupts the first white point such that an input video signal has a third white point corresponding to the corrupted first white point;
applying a correction to the input video signal to shift the third white point toward the first white point.

2. A method according to claim 1 wherein measuring ambient light conditions comprises providing one or more sensors to measure spectral content of ambient light, converting the measured spectral content into electronically conveyable data and transmitting the electronically conveyable data to a processor associated with the display system.

3. A method according to claim 2 wherein each sensor corresponds to a different spectral sensitivity over the visible wavelength range.

4. A method according to claim 1 wherein applying a correction to an input video signal comprises determining gain values consistent with the shift toward the first white point and applying the gain values to the input video signal.

5. A method according to claim 4 wherein determining gain values comprises determining tristimulus values corresponding to the third white point, scaling the tristimulus values and using the scaled tristimulus values to extract gain values from three or more three-dimensional gain maps.

6. A method according to claim 4 wherein applying the gain values to the input video signal comprises inputting the gain values into a P7 matrix and decomposing the input video signal.

7. A method according to claim 1 further comprising compensating for reflection adjustments.

8. A method according to claim 7 wherein applying a correction to an input video signal comprises determining tristimulus values corresponding to the third white point and wherein compensating for reflection adjustments comprises adjusting the tristimulus values using a reflection factor.

9. A method according to claim 1 further comprising defining an ambient light threshold and wherein applying a correction to an input video signal occurs only if ambient light conditions are above the ambient light threshold.

10. A method according to claim 1 wherein the ambient light has R, G, B values, the method further comprising defining a threshold for each of the R, G, B values and wherein applying a correction to an input video signal occurs only if the measured R, G, B values are each above the corresponding defined threshold.

11. A method according to claim 1 further comprising defining a white point change threshold for the second white point and monitoring the average white point change of the second white point over time and wherein applying a correction to an input video signal occurs only if the average white point change is below the white point change threshold.

12. A method for making automatic white point adjustments during video display, comprising:
providing a display system for displaying video images, the display system having an intended white point;
measuring ambient light conditions to account for corruption of the intended white point by ambient light;
storing three or more three-dimensional gain maps in a processor associated with the display system, the gain maps having gain values corresponding to shifts in white point; and
extracting gain values from the gain maps and applying the gain values to an input video signal, thereby adjusting the input video signal to compensate for ambient light corruption.

13. A method according to claim 12 wherein measuring ambient light conditions comprises providing one or more sensors to measure spectral content of ambient light and transmitting measured spectral data to the processor.

14. A method according to claim 12 further comprising adjusting the measured ambient light to account for reflection.

15. A method according to claim 12 further comprising defining an ambient light threshold and applying the gain values only when the ambient light threshold is met, and wherein applying the gain values comprises applying the gain values to the input video signal incrementally over time.

16. A method according to claim 12 wherein the ambient light has R, G, B values, the method further comprising defining a threshold for each of the R, G, B values and wherein applying the gain values to an input video signal occurs only if the measured R, G, B values are each above the corresponding defined threshold.

17. A method according to claim 12 further comprising monitoring the average white point change of ambient light over time and applying the gain values to an input video signal only if the average white point change is below an ambient light white point change threshold.

18. A system for making automatic white point adjustments during video display, comprising:
a display system having an intended white point, the display system operable to receive a video input signal;
one or more sensors associated with the display system, the one or more sensors operable to measure ambient light; and
a processor associated with the display system, the processor being operable to determine a correction to be applied to the video input signal to compensate for corruption of the intended white point by ambient light.

19. A system according to claim 18 wherein the display system comprises a digital rear projection television, a front projection system or a direct view device.

20. A system according to claim 18 further comprising an application-specific integrated circuit for receiving correction data from the processor, the application-specific integrated circuit being operable to apply the correction to the input video signal.
